(19) United States
(12) Patent Application Publication
(10) Pub. No.: US 2018/0093455 A1
(43) Pub. Date: Apr. 5, 2018

(54) SUBSTRATES, LAMINATES, AND ASSEMBLIES FOR FLEXIBLE HEATERS, FLEXIBLE HEATERS, AND METHODS OF MANUFACTURE

(71) Applicant: ROGERS CORPORATION, ROGERS, CT (US)

(72) Inventor: JIANHUA ZOU, NEWARK, DE (US)

(21) Appl. No.: 15/562,713

(22) PCT Filed: Mar. 29, 2016
(86) PCT No.: PCT/US16/24606

§ 371 Date: Sep. 28, 2017

Related U.S. Application Data
(60) Provisional application No. 62/141,024, filed on Mar. 31, 2015.

(51) Int. Cl. B32B 15/08; B32B 25/20; B32B 7/12; B32B 27/28; H05B 3/36; H05B 3/04

(52) U.S. Cl. CPC B32B 15/08; B32B 25/20; B32B 7/12; B32B 2038/0076; B32B 27/283; H05B 3/36; H05B 3/04; B32B 27/281

(57) ABSTRACT

A substrate for a flexible heater comprises a polyimide layer; a primer layer disposed on a first side of the polyimide layer; and a high-consistency silicone rubber adhesive layer calendered onto the first side of the polyimide layer.

### BACKGROUND

This disclosure relates to substrates and laminates used in the manufacture of assemblies for flexible heaters, the flexible heaters including the substrates, laminates, and assemblies, and methods for making the same.

Flexible heaters are widely used in a variety of applications such as pipes, automotive parts, batteries, computer equipment, medical equipment, optical equipment, and food service equipment. Flexible heaters typically comprise an electrically insulating substrate layer, which can be a material such as polymer or fiberglass mat, and an electrically conductive heating element, which can be in the form of wire wound or etched foil heating elements. A flexible heater can conform to the shape of the heated item and is generally manufactured to withstand a range of temperatures.

Various polymers have been used as the substrate of flexible heaters, including polyimides. The polyimide layers are often provided with an adhesive layer to improve bonding to the heating element. For example, flexible heater substrates can be made from polyimide/acrylic or polyimide/fluorinated ethylene-propylene (FEP) substrates. However, these substrates require high temperatures and long cure times during lamination, and although they can be used with etched foil heating elements, they are not suitable for flexible heaters with a wire wound heating element. Furthermore, the limited thermal stability of these substrates can limit their use to low-temperature applications, and can lead to reduced product longevity.

In order to solve these problems, a polymer substrate for flexible heaters is desired that is capable of use with either an etched or a wire wound heating element. It would be a further advantage if the substrates could be laminated at lower temperatures or for shorter times. Improved thermal stability compared to the polyimide/acrylic or polyimide/FEP substrates would also be an advantage. Development of an improved process for making a substrate for flexible heaters is also desired, which process would provide a substrate with high thermal stability that bonds well to metallic heating elements.

### SUMMARY

An embodiment provides a substrate for a flexible heater comprising a polyimide layer; a primer layer disposed on a first side of the polyimide layer; and a high-consistency silicone rubber adhesive layer calendered onto the first side of the polyimide layer, wherein the primer layer is disposed between the polyimide layer and the high-consistency silicone rubber adhesive layer.

Another embodiment provides a laminate for a flexible heater comprising a polyimide layer; a primer layer disposed on a first side of the polyimide layer; a high-consistency silicone rubber adhesive layer disposed on the first side of the polyimide layer, wherein the primer layer is disposed between the polyimide layer and the high-consistency silicone rubber adhesive layer; and an electrically conductive heating element disposed on a side of the silicone rubber adhesive layer that is opposite to the polyimide layer.

Another embodiment provides a laminate for a flexible heater comprising a polyimide layer; a primer layer disposed on a first side of the polyimide layer; a high-consistency silicone rubber adhesive layer calendered onto the first side of the polyimide layer, wherein the primer layer is disposed between the polyimide layer and the high-consistency silicone rubber adhesive layer; and a continuous, electrically conductive, flexible metal layer laminated onto a side of the silicone rubber adhesive layer that is opposite to the polyimide layer.

Another embodiment provides a laminate for a flexible heater comprising a first electrically insulative flexible polymer layer comprising a first polyimide layer, a primer layer disposed on a first side of the polyimide layer, a high-consistency silicone rubber adhesive layer calendered onto the first side of the polyimide layer, wherein the primer layer is disposed between the polyimide layer and the high-consistency silicone rubber adhesive layer; and a patterned, electrically conductive, flexible metal layer laminated onto a side of the silicone rubber adhesive layer that is opposite to the polyimide layer.

Still further disclosed are assemblies for flexible heaters and flexible electrical heaters that comprises the above polyimide/silicone substrates laminated to a metal layer.

### BRIEF DESCRIPTION OF THE DRAWINGS

Referring now to the figures, which are exemplary embodiments, and wherein like elements are numbered alike unless otherwise specified:

FIG. 1 is a schematic, cross-sectional view of a substrate for a flexible heater.

FIG. 2 is a schematic, cross-sectional view of a laminate for a flexible heater.

FIG. 3 is a schematic, cross-sectional view of an embodiment of an assembly for a flexible heater.

FIG. 4 shows a three-dimensional view of two embodiments of an assembly for flexible heater.

### DETAILED DESCRIPTION

The inventors hereof have discovered improved substrates, laminates, and assemblies for use in flexible heaters. In particular, the inventors have discovered that use of a calendered, high-consistency silicone rubber adhesive provides improved properties, including excellent adhesion to the heating element, particularly at elevated temperatures during use, and efficient manufacture, including fast, low-temperature lamination. The high-consistency silicone rubber adhesive is calendered onto a polyimide sheet or layer, on a side of the polyimide coated with a primer layer, to form an electrically insulated layer, to form a substrate for a flexible heater. The substrates can be used with either wire wound or etched foil heating elements. The substrates further provide a flexible heater that can be conformed into a variety of shapes at low cost, and can be produced simply and quickly.

FIG. 1 shows a flexible heater substrate 100 comprising a polyimide layer 200, which has disposed on one side an adhesion primer layer 300 as shown. As used herein, “disposed” means placed in direct contact with a primary element, or in contact with another element (e.g., a layer) that is in contact with the primary element. A high-consistency silicone rubber adhesive 400 is disposed onto a side of the polyimide layer 200, preferably on the primer layer 300, to provide the flexible heater substrate 100 of FIG. 1.

Polyimide is thermally resistant and has a high maximum operating temperature when used alone, but when laminated with other materials the operating temperature of the overall product may be limited by the thermal resistance of the non-polyimide materials. For example, maximum operating temperature is generally below 200° C. for polyimide/FEP laminates, and below 100° C. for polyimide/acrylic laminates. A polyimide/silicone laminate substrate, on the other hand, can have a maximum operating temperature up to 240° C., which allows the substrate to be used in applications which require heating to higher temperatures. Higher thermal stability would also likely lead to longer product life for the polyimide/silicone substrates.

The polyimide layer can be any suitable polyimide or polyetherimide such as KAPTON (poly (4,4′-oxydiphenylene-pyromellitimide)) sold by Dupont, APICAL sold by the Kaneka Corporation, UPILEX sold by Ube Industries, Polyimide TH/TL/BK from Taimide, or KAPTREX sold by Professional Plastics. Although described herein as polyimide layer 200, other polymers can be used in place of the polyimide in layer 200, provided that the polymer has the desired properties, for example one or more of flexibility, high temperature resistance, processability in the desired manufacturing conditions, and the like. Polymers that can be used include polyacetals, polyacrylates such as poly(methyl methacrylate), polyacrylonitriles, polyamides, polycarbonates, polydienes, polyesters, polyethers, polyetherether ketones, polyethersulfones, polyfluorocarbons, polyfluorochlorocarbons, polyketones, polyolefins such as polyethylene and polypropylene, polyoxazoles, polyphosphazenes, polysiloxanes, polystyrenes, polysulfones, polyurethanes, polyvinyl acetates, polyvinyl chlorides, polyvinylidene chlorides, polyvinyl esters, polyvinyl ethers, polyvinyl ketones, polyvinyl pyridines, polyvinyl pyrrolidones, and copolymers thereof, for example polyetherimide siloxanes, ethylene vinyl acetates, and acrylonitrile-butadiene-styrene. Specific polymers that are contemplated include polyimides, polyesters such as polyethylene terephthalate (PET), polybutylene terephthalate (PBT), and polyethylene naphthalate (PEN), polyetherimides, and polyetherimide siloxanes. In an embodiment, the polymer is selected to provide a transparent polymer layer such as PET.

The thickness of each of the polyimide layers can vary depending on the intended use of the flexible heater, in particular considerations such as cost and durability. For example the polyimide layers can have a thickness of 2 to 5,000 micrometers (μm) (0.08 to 200 mil), and in some embodiments the polyimide layers can have a thickness of 10 to 500 μm (0.4 to 20 mil), or 10 to 150 μm (0.4 to 5.9 mil). In some embodiments, any polyimide layer of the substrate can have a thickness from 10 μm (0.4 mil) to 150 μm (5.9 mil).

In some embodiments the polyimide layer is coated with an adhesion primer layer as shown in FIG. 1. Adhesion primers are known, and include, for example, multi-functional compounds reactive with the silicone and with the substrate, for example vinyl group- or substituted vinyl group-containing silanes. Such compounds include, for example, a vinyl tris(alkoxyalkoxy)silane. In an embodiment, the vinyl tris(alkoxyalkoxy)silane is present in an amount of 2-20 parts by weight, based on the total weight of the primer composition. In an embodiment, the vinyl tris(alkoxyalkoxy)silane is vinyl tris[(C₁-C₆alkoxy)(C₁-C₆alkoxy)]silane. In an embodiment, the vinyl tris(alkoxyalkoxy)silane is vinyl tris(2-methoxyethoxy) silane. While not preferred, the adhesion primer can be a compound such as poly(tetrafluoroethylene-co-hexafluoropropylene) (FEP), optionally blended with a second polymer selected from the group consisting of: polytetrafluoroethylene (PTFE), poly(tetrafluoroethylene-co-perfluoro[alkyl vinyl ether]) (PFA), poly(ethylene-co-tetrafluoroethylene) (ETFE) and copolymers, primer -1100 sold by Union Carbide, adhesion primer C sold by Shin-Etsu Chemical Corp. The primer can be present as a continuous or discontinuous layer. The primer can be applied by methods known in the art, for example, by coating. In some embodiments, any primer layer has a thickness from 1 μm (0.04 mil) to 2000 μm (80 mil). The thickness of each of the primer layers can vary depending on the polyimide and heating element, and the intended use of the flexible heater, in particular considerations such as cost and durability. For example the primer layers can have a thickness of 1 to 2,000 micrometers (μm) (0.04 to 80 mil), and in some embodiments the primer layers can have a thickness of 2 to 1000 μm (0.08 to 40 mil), or 2 to 100 μm (0.08 to 4 mil).

As used herein, “high consistency silicone compositions” or “high-consistency silicone rubber” refers to silicone compositions having a viscosity sufficiently high to be calendered before full cure, and that can be subsequently cured to provide a flexible, elastomeric composition effective to adhere the polyimide layer and the heating element as described in further detail below. Such compositions are known in the art, and generally comprise a peroxide-curable or platinum-catalyzed addition cure system. Other cure mechanisms can be used, for example condensation cure (acetoxy, alkoxy, or oxime), or photocuring. A combination of different cure systems can be used.

Peroxide cured silicones are most commonly used in high consistency rubbers, and cure a combination of vinyl-functional, hydride-functional, and optionally non-functional silicone prepolymers. The choice of peroxide catalyst is contingent on the cure technique and parameters desired (vinyl specific and non-vinyl specific). Examples of peroxide cure catalysts include bis(2,4-dichlorobenzoyl) peroxide, benzoyl peroxide, t-butyl perbenzoate, di-t-butyl peroxide, 2,5-dimethyl-2,5-di(t-butylperoxy)hexane, and dicumyl peroxide. The concentration of non-vinyl specific peroxide catalysts is directly proportional to the desired crosslink density of the cured elastomer. The peroxide can be premixed into the silicone at a weight ratio (organic peroxide to silicone) of 1×10⁻⁶:1 to 0.1:1, or 1×10⁻⁵:1 to 0.01:1, preferably 4×10⁻⁴:1 to 2×10³:1, and more preferably 2×10⁻⁴:1 to 2×10⁻²:1. Typical cure schedules of non-vinyl specific peroxide catalyzed elastomers can be 1 to 20 minutes at 90 to 140° C., followed with a 2-4 hour “post cure” at higher temperatures (e.g., 150 to 177° C.), to remove residual by-products. Alternatively, such silicone compositions can be subsequently crosslinked at temperatures of 190° F. to 350° F., or 230° F. to 310° F., with dwell times of 1 to 5 hours, or 0.5 to 4 hours. Alternatively, a typical cure schedule of non-vinyl specific peroxide catalyzed elastomers can be 1 to 60 minutes at room temperature, followed by a “post cure” at higher temperatures. Of course, one skilled in the art will appreciate that optimal crosslinking temperatures and dwell times may vary, depending on such factors as the ratio of crosslinking agent to silicone, the quantity of silicone, the degree of partial crosslinking desired, and the particular equipment used.

Addition cured silicone elastomers are commonly referred to as platinum catalyzed silicones and are generally two-part systems with each part containing different functional components where generally, the Part A component contains vinyl functional silicones and the platinum catalyst, whereas the Part B contains vinyl functional polymer, hydrogen-functional crosslinker, and cure inhibitor, which can be used to adjust the cure rate of the system. The cure chemistry involves the direct addition of the Si—H functional crosslinker to the vinyl functional polymer forming an ethylene bridge crosslink. The vulcanization of addition cured silicone elastomers can be heat accelerated. Depending on the specific product, addition cured elastomers can be fully cured at temperatures and times from 20 minutes at 110° C. to 2 minutes at 150° C.

Examples of curable high consistency silicone rubber compositions that can be used include SILASTIC from Dow Corning, XIAMETER from Dow Corning, the IS800 series of adhesives from Momentive Performance Materials, and the ELASTOSIL R series of self-sticking adhesives from Wacker.

The thickness of each of the silicone adhesive layers can vary depending on the intended use of the flexible heater, in particular considerations such as cost and durability. For example the silicone adhesive layers can have a thickness of 2 to 10,000 micrometers (μm) (0.08 to 400 mil), and in some embodiments the silicone adhesive layers can have a thickness of 10 to 1000 μm (0.4 to 40 mil), or 10 to 300 μm (0.4 to 11.8 mil). Any silicone adhesive layer of the substrate can have a thickness from 10 μm (0.4 mil) to 150 μm (5.9 mil).

The materials for the flexible heater substrates or laminates, in particular the materials used for the polyimide layer(s), the silicone adhesive layer(s), the optional primer layer(s), and the metal layer(s), can be selected so that the substrate or laminate is transparent or translucent. For example, the substrate or laminate can have a transparency of greater than 50%, greater than 70%, greater than 80%, or greater than 90%. Transparency can be determined, for example, by ASTM D1003-00.

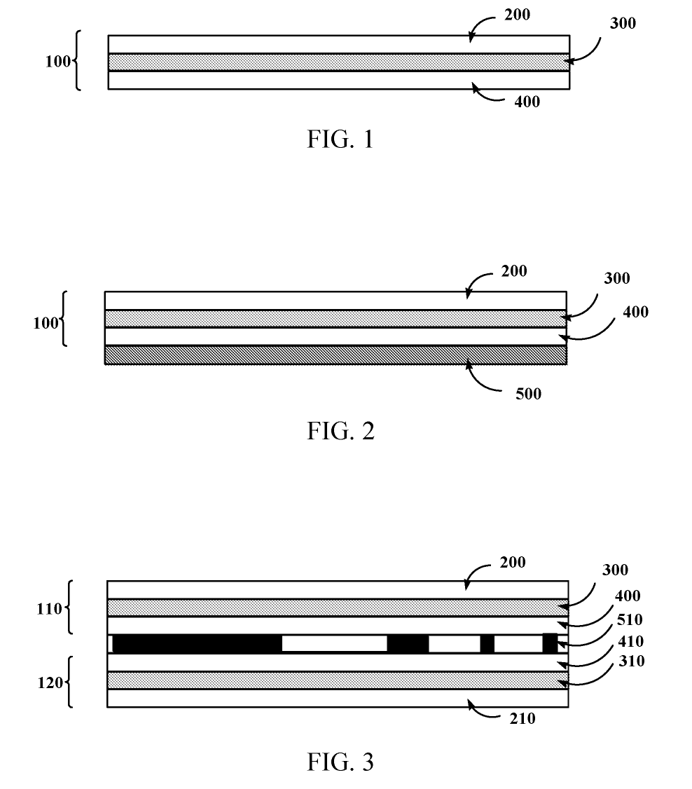

FIG. 2 shows a laminate for a flexible heater comprising the flexible substrate 100 and an electrically conductive metal layer 500, also referred to herein as an electrical resistance metal layer 500. The electrical resistance metal layer 500 is disposed on the side of the silicone adhesive layer 400 that is opposite the polyimide layer 200. In an alternative embodiment (not shown) electrical resistance metal layer 500 can be an electrical heating element, that is, a patterned metal layer or an electrical resistance metal wire wound heating element disposed on the silicone adhesive layer 400.

The electrical resistance metal can be a metal such as stainless steel, copper, aluminum, nickel, chromium, or an alloy comprising at least one of the above mentioned metals. The electrical resistance metal layer can, for example, be a nickel-chromium alloy available under the name Inconel, which is oxidation and corrosion resistant and can operate in extreme environments. Nichrome is another nickel/chromium alloy suitable for use in flexible heating elements. The electrical resistance metal is selected such that it will generate heat when an electric current is passed through it.

The thickness of the electrical resistance metal layer can vary depending on the intended use of the flexible heater, in particular considerations such as cost and durability. For example, the metal layer can have a thickness of 2 to 10,000 micrometers (μm) (0.08 to 400 mil), and in some embodiments the silicone adhesive layers can have a thickness of 10 to 5000 μm (0.4 to 80 mil), or 10 to 2000 μm (0.4 to 40 mil). In some embodiments, the electrical resistance metal layer of the laminate has a thickness from 10 μm (0.4 mil) to 1000 μm (40 mil).

The electrical resistance metal layer can be a continuous metal layer as shown or a discontinuous layer. The continuous metal layer can be used as the heating element directly, or can be etched in a later step to produce a patterned metal layer that provides the heating element. Alternatively, the discontinuous metal layer can be a wire wound element. Etched foil elements are generally made from a continuous metal layer which is subjected to an etching process after lamination. Wire wound elements are particularly well-suited for larger heating elements, low watt densities, and smaller production runs. Also, as the wires can be very thin, it can be used in transparent flexible heaters without blocking as much light transmission as an etched foil element. The wire wound element is formed from wires which are wound into a pattern that allows heating over the desired portion of the surface of the flexible heater. The wire wound element can be formed separately and then laid or laminated onto the flexible heater substrate, or it can be wound directly onto the substrate.

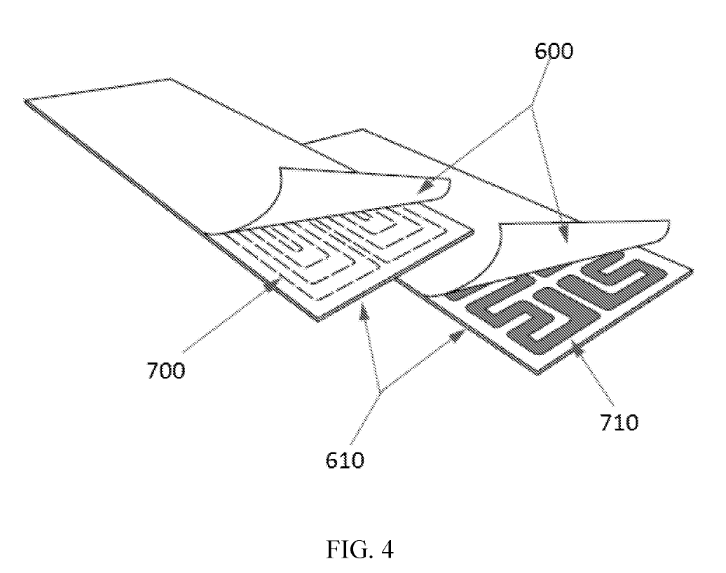

The substrates and laminates described above can be used in the manufacture of an assembly for a flexible heater as shown schematically in FIG. 4. Two embodiments of an assembly are shown. One assembly shown comprises a flexible heater substrate layer 610 as described above (i.e., flexible heater substrate 100), wherein discontinuous metal layer 700 is a wire wound electrical resistance heating element. The other assembly shown comprises a substrate layer 610 as described above and a discontinuous metal layer 710 which is an etched metal electrical resistance heating element. The heating elements 700, 710 are disposed on the silicone adhesive layer of the substrate layer 610. An electrically insulative, flexible polymer layer 600 is disposed on a side of the heating elements 700, 710 opposite the substrate layer 610, in particular opposite the silicone adhesive layer of the substrate 610. In some embodiments the substrate layer 610 and the electrically insulative flexible polymer layer 600 are not identical, and may comprise different materials or be of different thicknesses. For example, polymer layer 600 can be any flexible insulative polymer layer (e.g., polyetherimide, or a substrate comprising a polyimide/acrylic or polyimide/fluorinated ethylene-propylene substrate).

In preferred embodiments, the substrate layer 610 and the electrically insulative flexible polymer layer 600 are the same, such that polymer layer 600 also comprises a substrate material as described above. With reference to FIG. 3, an assembly for a flexible heater comprises a first substrate layer 120, a discontinuous metal layer 510 in the desired form of the resistance heating element, and a second electrically insulative substrate layer 110 disposed onto the electrical resistance heating element 510 on a side opposite the first substrate layer, such that the heating element 510 is disposed between the first and second substrates 110 and 120, as shown. In particular, the heater assembly in FIG. 3 comprises a substrate layer 110, which comprises a polyimide (or other polymer) layer 200, an adhesion primer 300 disposed on one side thereof, and a high-consistency silicone rubber adhesive layer 400 disposed on the primer layer 300 and another substrate layer 120 which comprises a polyimide (or other polymer) layer 210, an adhesion primer 310 disposed on one side thereof, and a high-consistency silicone adhesive layer 410 disposed on the primer layer 310. As stated above, polymers other than polyimide can be used in layers 200, 210, provided that the polymer has the desired properties.

In a method of manufacturing a flexible substrate for a flexible heater, a polyimide layer 200 is coated on one side with an adhesion primer 300, and a high-consistency silicone rubber adhesive 400 is calendered onto the primed side of polyimide layer 200 to provide the flexible heater substrate 100. The silicone adhesive can be uncured before calendering, partially cured before calendering, or partially cured after calendering. In some embodiments, the silicone rubber adhesive is uncured when calendered, and becomes partially cured (B-staged) upon standing at room temperature, for example 20 to 26° C. (68 to 79° F.) for 1 to 5 days, or 2 to 4 days, or 3 days. Alternatively the adhesive can be B-staged after calendering by subjecting the substrate to partial cure conditions.

Calendering is known in the art, and a variety of equipment and conditions can be used. For example, either a 3-roll or 4-roll calender can be used. The 4-roll unit offers the advantage of working air out of the rubber more thoroughly. A variable-speed main drive allows adjustment of roll speeds. For example a center roll speed can be 0.1 to 5, or 0.6 to 3 surface meter per minute. The calender can be set for skim coating or “even”; i.e. the center and bottom rolls turn at the same rate, and turn faster than the top roll. In some embodiments, particularly with stiffer compositions rubber, an “odd” speed where the center and bottom rolls turn at different rates gives better results. Silicone rubber is usually calendered at room temperature. However, heating the rolls can be used to reduce sticking, provided that the heating does not prematurely cure the silicone or cause decomposition. The silicone can be calendared onto a release layer, for example a polyethylene release layer, and then layered with the polyimide layer. Preferably, the silicone adhesive is calendered directly onto the polyimide layer.

To manufacture the laminate, the flexible heater substrate is layered with the electrical resistance metal layer and is subjected to lamination to adhere the silicone adhesive and the metal layer, and to cure the silicone adhesive. During lamination, the layers of the assembled substrate are held together by pressure, and the substrate is heated at temperatures and for times effective to completely cure the adhesive. For example, in some embodiments the flexible heater substrate and metal layer are placed inside a set of plates with clamps and heated for 5 to 180 minutes at a temperature from 100° C. to 230° C. (212° F. to 446° F.). In other embodiments the flexible heater substrate and metal layer is heated for 10 to 60 minutes at 100° C. to 150° C. (212° F. to 302° F.), or for 15 to 30 minutes at 110° C. to 130° C. (230° F. to 266° F.). Alternatively, the laminate can be stored or sold partially cured, and then at a later time completely cured.

When the laminate is constructed using a continuous metal layer, the continuous metal layer can be etched after lamination by a subtractive etching process, such as a photo-etching process, to produce a foil with a complex resistance pattern. Photo-etching generally proceeds through the following steps. First, a photoimageable resist is applied to the metal layer. Then a mask layer, which specifies the dimensions and shape of the heater, is then placed over the resist. Finally, an etching step subjects the metal layer to chemical etching and cleaning cycles which removes metal that is unprotected by the mask layer, leaving the desired shape of the etched foil heating element. Alternatively, a wire wound heating element can be formed onto the silicone adhesive layer, or formed separately and then laminated onto the flexible heater substrate.

Assemblies for use in flexible heaters can be manufactured using the above substrates or laminates. For example, in an embodiment, a partially or fully cured laminate can be layered with a flexible polymer layer or a second polyimide/silicone substrate and laminated as described to form the assembly. Alternatively, a metal layer can be disposed onto a first uncured or partially cured silicone adhesive layer of a first substrate; the uncured or partially cured silicone adhesive of a second substrate layer can be stacked onto a side of the electrical resistance metal layer opposite the first silicone adhesive layer; and the stack can be laminated as described above to adhere the layers and fully cure the adhesives.

Flexible heaters comprising the substrates, laminates, and assemblies are also disclosed. Methods and components for converting the substrates, laminates, and assemblies into flexible heaters are known to those of ordinary skill in the art. The flexible heaters can be used in a wide variety of applications, for example to heat a battery, so that the battery will retain power in extreme cold. Such batteries could be used in vehicles, outdoor equipment such as snowmaking machinery, medical equipment such as infusion pumps, and for other uses.

Although flexible heater substrates can be made from polyimide/acrylic and polyimide/FEP, the polyimide/silicone substrates, laminates, and assemblies have several advantages over these materials. To cure a laminate for a flexible heater comprising a substrate and a metal layer typically requires heating at 180° C. (356° F.) for 2 hours for a polyimide/acrylic substrate, and 290° C. (554° F.) for 1 hour for a polyimide/FEP substrate. These high curing temperatures and times result in higher than desired production cost and time. A laminate comprising the substrate of the present disclosure and a metal layer can be cured at 120° C. (248° F.) for 15 minutes, which represents a great improvement over the prior art substrates, and would be expected to reduce the cost and time of production. Neither the polyimide/acrylic or polyimide/FEP substrates bond well to wire wound heating elements, but the polyimide/silicone substrates and laminates do bond well to wire wound heating elements, thus representing another advantage of the present invention over the prior art.

In addition, the substrates, laminates, and flexible heater assemblies can have excellent thermal stability. For example, the Relative Thermal index is a known property that indicates how a polymer's properties degrade after being subjected to heat aging. Materials are investigated with respect to retention of certain critical properties (e.g., dielectric strength, flammability, impact strength, and tensile strength) as part of a long-term thermal-aging program conducted in accordance with Underwriters Laboratories, Inc. Standard for Polymeric Materials-Long Term Property Evaluations (UL746B).

In some embodiments, the substrates, laminates, and assemblies can be exposed to a temperature of 180° C. for 100,000 hours with a 50% or less loss of one or more of strength (e.g., tensile strength) or electrical properties. In other embodiments, the substrates, laminates, and assemblies can be exposed to a temperature of 200° C. for 100,000 hours with a 50% or less loss of strength or electrical properties. In other embodiments, the substrates, laminates, and assemblies can be exposed to a temperature of 220° C. for 100,000 hours with a 50% or less loss of strength or electrical properties. In a specific embodiment, the substrates, laminates, and assemblies can be exposed to a temperature of 200° C. for 100,000 hours with a 50% or less loss of strength (e.g., tensile strength) and exposed to a temperature of 240° C. for 100,000 hours with a 50% or less loss of electrical properties.

The claims are further described and illustrated in examples provided below, which are, however, not intended to limit the scope of the invention.

### EXAMPLE 1

A polyimide sheet (KAPTON HN) of 2 mil (50 μm) thickness was sprayed with adhesive primer, and a sheet of silicone rubber adhesive of 3 mil (76 μm) thickness was calendered onto the primed side of the KAPTON HN and interleaved with 2.5 mil (64 μm) polyethylene as a release liner. The resulting substrate was cut to size and could be packaged if desired, or used directly to produce laminates with additional layers.

### EXAMPLE 2

1 mil (25 μm) INCONEL 600 was laid onto the exposed silicone rubber side of the substrate from Example 1. The material was pressed together at a pressure of 16 psi and then cured through an IR heater at 600° F. at a line speed of 5 feet per minute (fpm). The resulting laminate could be further processed to produce a flexible heater.

The substrate, laminate, assembly, electrical resistance heater and their methods of manufacture are further illustrated by the following embodiments, which are non-limiting.

### Embodiment 1

A substrate for a flexible heater comprising a polymer layer, preferably a polyimide layer; a primer layer disposed on a first side of the polymer layer; and a high-consistency silicone rubber adhesive layer calendered onto the primer layer.

### Embodiment 2

A laminate for a flexible heater comprising a polymer layer, preferably a polyimide layer; a primer layer disposed on a first side of the polymer layer; a high-consistency silicone rubber adhesive layer calendered onto the primer layer; and a continuous, electrical resistance metal layer laminated onto a side of the silicone rubber adhesive layer that is opposite to the primer layer.

### Embodiment 3

A laminate for a flexible heater comprising a polymer layer, preferably a polyimide layer; a primer layer disposed on a first side of the polymer layer; a high-consistency silicone rubber adhesive layer disposed on the primer layer; and an electrical resistance heating element disposed on a side of the silicone rubber adhesive layer that is opposite to the polymer layer.

### Embodiment 4

The laminate of Embodiment 3, wherein the electrical resistance heating element is an etched heating element or wire wound heating element.

### Embodiment 5

An assembly for a flexible heater comprising laminate of any one or more of Embodiments 3 to 4, and an electrically insulative, flexible polymer layer disposed on the heating element on a side opposite the silicone rubber adhesive layer.

### Embodiment 6

An assembly for a flexible heater comprising a laminate of any one or more of Embodiments 3 to 4, and a second substrate laminated onto the electrical resistance heating element on a side opposite the silicone rubber adhesive layer, wherein the second substrate comprises a second polymer layer, preferably a second polyimide layer, a second primer layer disposed on a first side of the second polymer layer, and a second high-consistency silicone rubber adhesive layer calendered onto the first side of the second polymer layer, preferably the second polyimide layer, wherein the second primer layer is disposed between the second polymer layer, preferably the second polyimide layer and the second high-consistency silicone rubber adhesive layer; and wherein the electrical resistance heating element is laminated to a side of the second high-consistency silicone rubber adhesive layer that is opposite to the second polymer layer.

### Embodiment 7

The substrate, laminate, or assembly of any one or more of Embodiments 1 to 6, wherein any polymer layer, preferably any polyimide layer, has a thickness from 10 μm to 150 μm.

### Embodiment 8

The substrate, laminate, or assembly of any one or more of Embodiments 1 to 7, wherein any silicone rubber adhesive layer has a thickness from 10 μm to 300 μm.

### Embodiment 9

The substrate, laminate, or assembly of any one or more of Embodiments 1 to 8, wherein the substrate has a maximum operating temperature from 180 to 240° C.

### Embodiment 10

The laminate or assembly of any one or more of Embodiments 2 to 9, wherein the metal layer or the heating element comprises stainless steel, copper, aluminum, nickel, chromium, or an alloy comprising at least one of the foregoing.

### Embodiment 11

A process for producing the substrate, laminate, or assembly of any one or more of Embodiments 1 to 10, the process comprising calendering a high-consistency silicone rubber adhesive layer onto a primed side of a polymer layer, preferably a polyimide layer, to form an electrically insulative flexible polymer layer; and partially curing the calendered silicone rubber adhesive layer.

### Embodiment 12

A process for producing the laminate or assembly of any one or more of Embodiments 2 and 7 to 10, the process comprising calendering a high-consistency silicone rubber adhesive layer onto a primed side of a polymer layer, preferably a polyimide layer; disposing a continuous electrical resistance metal layer onto a side of the silicone rubber adhesive layer that is opposite to the polymer layer; and partially or fully curing the silicone rubber adhesive layer.

### Embodiment 13

A process for producing the laminate or assembly of any one or more of Embodiments 2 and 7 to 10, the process comprising calendering a high-consistency silicone rubber adhesive layer onto a primed side of a polymer layer, preferably a polyimide layer; partially curing the adhesive layer; disposing a continuous electrical resistance metal layer onto a side of the silicone rubber adhesive layer that is opposite to the polymer layer; and laminating the layers under conditions effective to fully cure the silicone rubber adhesive layer.

### Embodiment 14

A process for producing the laminate or assembly of any one or more of Embodiments 2 to 10, the process comprising calendering a high-consistency silicone rubber adhesive layer onto a primed side of a polymer layer, preferably a polyimide layer; disposing an electrical resistance heating element onto a side of the silicone rubber adhesive layer that is opposite to the polymer layer; and partially or fully curing the silicone rubber adhesive layer.

### Embodiment 15

A process for producing the laminate or assembly of any one or more of Embodiments 2 to 10, the process comprising calendering a high-consistency silicone rubber adhesive layer onto a primed side of a polymer layer, preferably a polyimide layer; partially curing the adhesive layer; disposing an electrical resistance heating element onto a side of the silicone rubber adhesive layer that is opposite to the polymer layer; and laminating the layers under conditions effective to fully cure the silicone rubber adhesive layer.

### Embodiment 16

A process for producing an assembly of any one or more of Embodiments 5 to 10, the process comprising calendering a high-consistency silicone rubber adhesive layer onto a primed side of a polymer layer, preferably a polyimide layer, to form a first substrate; disposing an electrical resistance heating element onto a side of the silicone rubber adhesive layer that is opposite to the first polymer layer; disposing an electrically insulative, flexible polymer layer on the heating element on a side opposite the silicone rubber adhesive layer; and curing the silicone rubber adhesive layer.

### Embodiment 17

A process for producing an assembly of any one or more of Embodiments 5 to 10, the process comprising calendering a first high-consistency silicone rubber adhesive layer onto a primed side of a first polymer layer, preferably a first polyimide layer, to form a first substrate; calendering a second high-consistency silicone rubber adhesive layer onto a primed side of a second polymer layer, preferably a second polyimide layer, to form a second substrate; disposing an electrical resistance heating element between the calendered high-consistency silicone rubber adhesive layers of the first and second substrates to form a stack; and laminating the stack under conditions effective to cure the first and the second silicone rubber adhesive layers.

### Embodiment 18

A process for producing an assembly of any one or more of Embodiments 5 to 10, the process comprising calendering a first high-consistency silicone rubber adhesive layer onto a primed side of a first polymer layer, preferably a first polyimide layer, to form a first substrate; calendering a second high-consistency silicone rubber adhesive layer onto a primed side of a second polymer layer, preferably a second polyimide layer, to form a second substrate; disposing a continuous electrical resistance metal layer onto the first calendered silicone rubber adhesive layer on a side opposite the first polymer layer; laminating the first substrate and metal layer at a temperature effective to cure the silicone adhesive to form a laminate; etching the metal layer to form an electrical heating element; contacting a side of the second calendered silicone layer of the second substrate opposite the second polymer layer with a side of the metal layer opposite the first cured silicone rubber layer to form a stack; and laminating the stack under conditions effective to cure the second silicone rubber adhesive layer.

### Embodiment 19

The process of any one or more of embodiments 11 to 18, further comprising curing or laminating for 5 to 180 minutes at a temperature from 100° C. to 230° C., for 10 to 60 minutes at 100° C. to 150° C., or for 15 to 30 minutes at 110° C. to 130° C.

### Embodiment 20

An electrical resistance heater comprising the substrate, laminate, or assembly of any one or more of Embodiments 1 to 19.

In general, the compositions or methods may alternatively comprise, consist of, or consist essentially of, any appropriate components or steps herein disclosed. The invention may additionally, or alternatively, be formulated so as to be devoid, or substantially free, of any components, materials, ingredients, adjuvants, or species, or steps used in the prior art compositions or that are otherwise not necessary to the achievement of the function and/or objectives of the present claims.

The terms “a” and “an” do not denote a limitation of quantity, but rather denote the presence of at least one of the referenced item. The term “or” means “and/or” unless clearly indicated otherwise by context. The endpoints of all ranges directed to the same component or property are inclusive of the endpoints, are independently combinable, and include all intermediate points and ranges. The terms “first,” “second,” and the like, “primary,” “secondary,” and the like, as used herein do not denote any order, quantity, or importance, but rather are used to distinguish one element from another. The term “combination” is inclusive of blends, mixtures, alloys, reaction products, and the like. Unless defined otherwise, technical and scientific terms used herein have the same meaning as is commonly understood by one of skill in the art to which this invention belongs.

The polyimide/silicone substrates and laminates for a flexible heater according to detailed embodiments and the process of preparing the same are explained in more detail. However, they are merely presented as an example of the present invention, and thus it is clearly understood to a person skilled in the art that the scope of the present invention is not limited to the detailed embodiments, and that various modifications and executions are possible and are within the scope of the present invention.

1. (canceled)

2. (canceled)

3. A laminate for a flexible heater comprising
a polymer layer;
a primer layer disposed on a first side of the polymer layer;
a high-consistency silicone rubber adhesive layer disposed on the primer layer; and
an electrical resistance heating element disposed on a side of the silicone rubber adhesive layer that is opposite to the polymer layer.

4. The laminate of claim 3, wherein the electrical resistance heating element is an etched heating element or wire wound heating element.

5. An assembly for a flexible heater comprising
the laminate of claim 3, and
an electrically insulative, flexible polymer layer disposed on the heating element on a side opposite the silicone rubber adhesive layer.

6. An assembly for a flexible heater comprising
the laminate of claim 3, and
a second substrate laminated onto the electrical resistance heating element on a side opposite the silicone rubber adhesive layer, wherein the second substrate comprises
a second polymer layer,
a second primer layer disposed on a first side of the second polymer layer, and
a second high-consistency silicone rubber adhesive layer calendered onto the first side of the second polymer layer, wherein the second primer layer is disposed between the second polymer layer and the second high-consistency silicone rubber adhesive layer; and
wherein the electrical resistance heating element is laminated to a side of the second high-consistency silicone rubber adhesive layer that is opposite to the second polymer layer.

7. The laminate of claim 3, wherein the polymer layer has a thickness from 10 μm to 150 μm.

8. The laminate of claim 3, wherein any silicone rubber adhesive layer has a thickness from 10 μm to 300 μm.

9. (canceled)

10. The laminate of claim 3, wherein the heating element comprises stainless steel, copper, aluminum, nickel, chromium, or an alloy comprising at least one of the foregoing.

11. (canceled)

12. (canceled)

13. (canceled)

14. A process for producing the laminate of claim 3, the process comprising
calendering a high-consistency silicone rubber adhesive layer onto a primed side of a polymer layer;
disposing an electrical resistance heating element onto a side of the silicone rubber adhesive layer that is opposite to the polymer layer; and
partially or fully curing the silicone rubber adhesive layer.

15. A process for producing the laminate of claim 3 the process comprising
calendering a high-consistency silicone rubber adhesive layer onto a primed side of a polymer layer;
partially curing the adhesive layer;
disposing an electrical resistance heating element onto a side of the silicone rubber adhesive layer that is opposite to the polymer layer; and
laminating the layers under conditions effective to fully cure the silicone rubber adhesive layer.

16. A process for producing an assembly of claim 6, the process comprising
calendering a high-consistency silicone rubber adhesive layer onto a primed side of a polymer layer to form a first substrate;
disposing an electrical resistance heating element onto a side of the silicone rubber adhesive layer that is opposite to the first polymer layer;
disposing an electrically insulative, flexible polymer layer on the heating element on a side opposite the silicone rubber adhesive layer; and
curing the silicone rubber adhesive layer.

17. A process for producing an assembly of claim 6, the process comprising
calendering a first high-consistency silicone rubber adhesive layer onto a primed side of a first polymer layer to form a first substrate;
calendering a second high-consistency silicone rubber adhesive layer onto a primed side of a second polymer layer to form a second substrate;
disposing an electrical resistance heating element between the calendered high-consistency silicone rubber adhesive layers of the first and second substrates to form a stack; and
laminating the stack under conditions effective to cure the first and the second silicone rubber adhesive layers.

18. A process for producing an assembly of claim 6, the process comprising
calendering a first high-consistency silicone rubber adhesive layer onto a primed side of a first polymer layer, to form a first substrate;
calendering a second high-consistency silicone rubber adhesive layer onto a primed side of a second polymer layer, to form a second substrate;
disposing a continuous electrical resistance metal layer onto the first calendered silicone rubber adhesive layer on a side opposite the first polymer layer;
laminating the first substrate and metal layer at a temperature effective to cure the first silicone adhesive layer to form a laminate;
etching the metal layer to form an electrical heating element;
contacting a side of the second calendered silicone layer of the second substrate opposite the second polymer layer with a side of the metal layer opposite the first cured silicone rubber layer to form a stack; and
laminating the stack under conditions effective to cure the second silicone rubber adhesive layer.

19. (canceled)

20. An electrical resistance heater comprising the laminate of claim 3.

21. A laminate for a flexible heater comprising
a polymer layer;
a primer layer disposed on a first side of the polymer layer;
a high-consistency silicone rubber adhesive layer calendered onto the primer layer; and
a continuous, electrical resistance metal layer laminated onto a side of the silicone rubber adhesive layer that is opposite to the primer layer.

22. The laminate of claim 21, wherein the polymer layer has a thickness from 10 μm to 150 μm.

23. The laminate of claim 21, wherein the silicone rubber adhesive layer has a thickness from 10 μm to 300 μm.

24. The laminate of claim 21, wherein the metal layer comprises stainless steel, copper, aluminum, nickel, chromium, or an alloy comprising at least one of the foregoing.

25. A process for producing the laminate of claim 21, the process comprising
calendering a high-consistency silicone rubber adhesive layer onto a primed side of a polymer layer;
disposing a continuous electrical resistance metal layer onto a side of the silicone rubber adhesive layer that is opposite to the polymer layer; and
partially or fully curing the silicone rubber adhesive layer.

26. A process for producing the laminate of claim 21, the process comprising
calendering a high-consistency silicone rubber adhesive layer onto a primed side of a polymer layer;
partially curing the adhesive layer;
disposing a continuous electrical resistance metal layer onto a side of the silicone rubber adhesive layer that is opposite to the polymer layer; and
laminating the layers under conditions effective to fully cure the silicone rubber adhesive layer.

27. An electrical resistance heater comprising the laminate of claim 21.
